(19) United States
(12) Patent Application Publication
(10) Pub. No.: US 2005/0093771 A1
(43) Pub. Date: May 5, 2005

(54) Vehicle graphic system

(76) Inventor: Joseph Scott, Katy, TX (US)

Correspondence Address: BUSKOP LAW GROUP, P.C., 1717 ST. JAMES PLACE, SUITE 500, HOUSTON, TX, 77056, US

(21) Appl. No.: 10/673,991

(22) Filed: Sep. 29, 2003

(51) Int. Cl. G09G 3/00

(52) U.S. Cl. 345/30

(57) ABSTRACT

A vehicle graphic system is described herein. The vehicle graphic system generally includes a replaceable, removable vehicular exterior part, wherein the vehicular exterior part includes an interior side and an exterior side, a graphic cutout formed in the exterior part and extending through the interior side and the exterior side, a lighting assembly disposed proximate the interior side of the vehicular exterior part, wherein the lighting assembly is adapted to illuminate the graphic cutout, a power source operably connected to the lighting assembly and a support bracket adapted for supporting the lighting assembly on the interior side of the part.

### FIELD OF THE INVENTION

Embodiments described herein relate to a vehicle messaging system.

### BACKGROUND OF THE INVENTION

Vehicle owners have had an interest in displaying illuminated graphics, such as symbols or messages on their vehicles, but to date have not had a convenient way to do such. In particular, motorcycle owners have expressed an interest in displaying graphics on portions of their motorcycles.

Therefore, there is a need for a vehicle graphic system.

### SUMMARY OF THE INVENTION

Embodiments of the invention generally include a vehicle graphic system. The vehicle graphic system generally includes a replaceable, removable vehicular exterior part, wherein the vehicular exterior part includes an interior side and an exterior side, a graphic cutout formed in the exterior part and extending through the interior side and the exterior side, a lighting assembly disposed proximate the interior side of the vehicular exterior part, wherein the lighting assembly is adapted to illuminate the graphic cutout, a power source operably connected to the lighting assembly and a support bracket adapted for supporting the lighting assembly on the interior side of the part.

Embodiments of the invention further include a motorcycle graphic system. The motorcycle graphic system generally includes a replaceable, removable motorcycle exterior part, wherein the vehicular exterior part includes an interior side and an exterior side, a graphic cutout formed in the exterior part and extending through the interior side and the exterior side, a lighting assembly disposed proximate the interior side of the motorcycle exterior part, wherein the lighting assembly is adapted to illuminate the graphic cutout, a power source operably connected to the lighting assembly and a support bracket adapted for supporting the lighting assembly on the interior side of the part.

### BRIEF DESCRIPTION OF THE DRAWINGS

The present invention will be described further with reference to the appended drawings, in which:

FIG. 1 depicts a front view of a vehicle graphic system;

FIG. 2 depicts a side view of the vehicle graphic system;

The present invention is detailed below with reference to the listed Figures.

### DETAILED DESCRIPTION OF THE PREFERRED EMBODIMENTS

Before explaining the present invention in detail, it is to be understood that the invention is not limited to the particular embodiments and that it can be practiced or carried out in various ways.

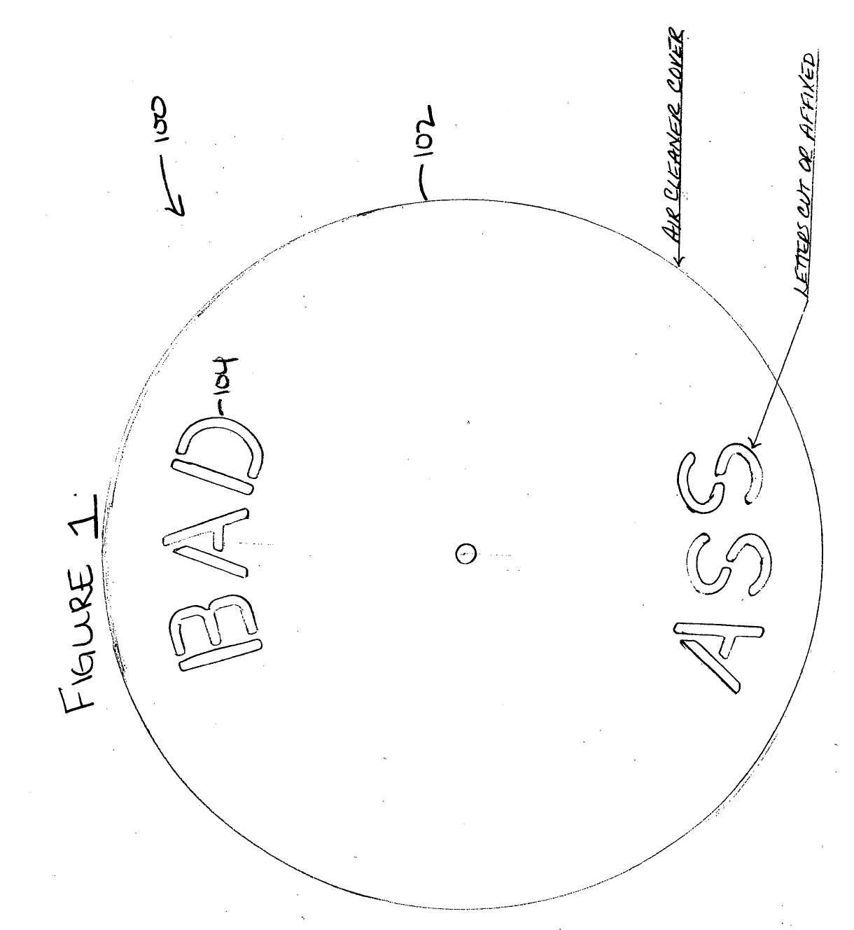

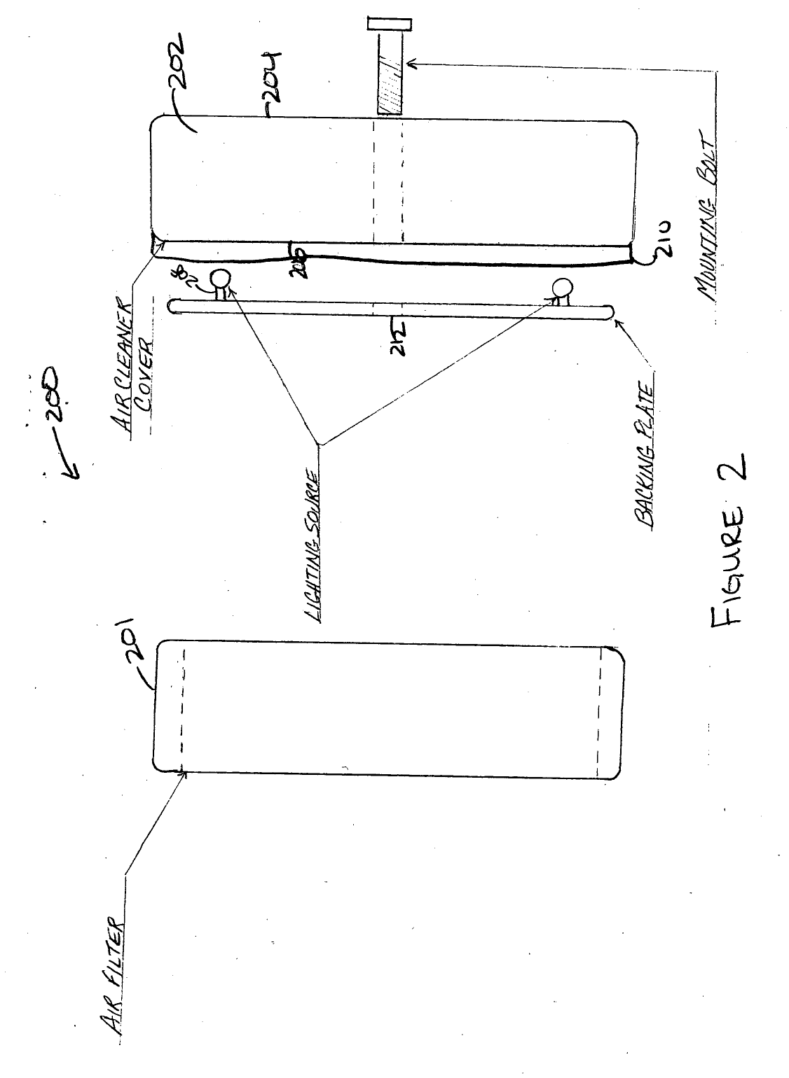

FIG. 1 illustrates a front view of a vehicle graphic system 100. The vehicle graphic system 100 generally includes a replaceable, removable vehicular exterior part 102 operably connected to a portion of a vehicle 201, shown in more detail in FIG. 2, wherein the vehicular exterior part 202 includes an interior side 206 and an exterior side 204. The replaceable, removable vehicular exterior part 202 generally includes a graphic cutout 104 formed in the exterior part 202 and extending through the interior side 206 and the exterior side 204. The graphic cutout 104 an include a message or symbol, for example. Further, the graphic cutout can be formed by ways known to one skilled in the art, such as laser jet cutting, water cutting or stamping.

The replaceable, removable vehicular exterior part 202 can include a battery cover, a horn cover, a valve cover, a gas tank attachment, a front fender attachment, a front fender, a rear fender, a rear fender attachment, a carburetor cover or an engine cover, for example. Preferably, the vehicular exterior part 202 is an air filter cover.

Further, the vehicular exterior part 202 can be an automobile part, a motorcycle part, or a boat part, an RV part, a truck part or an eighteen-wheeler, for example. Preferably, the vehicular exterior part 202 is a motorcycle part, which can be bolted onto the motorcycle.

The graphic cutout 104 can further be lined with a transparent material 210, such as a tinted material or a polarized material. Preferably, the interior side 206 of the graphic cutout is lined with the transparent material 210. Alternatively, the exterior side 204 can be lined with the transparent material. The transparent material 210 can be mounted on the vehicular exterior part 202 to extend over the entire part 202 or the transparent material 210 can include a plurality of pieces, each extending over only a portion of the part 202.

The vehicle graphic system 200 further includes a lighting assembly 208 disposed proximate the interior side 206 of the vehicular exterior part 202, wherein the lighting assembly 208 is adapted to illuminate the graphic cutout from within. In one embodiment, the lighting assembly 208 includes a plurality of lighting sources, such as fiber optic filaments, neon lights, LED or incandescent lights. For example, the plurality of lighting sources can include at least a first lighting source and at least a second lighting source, the first lighting source adapted to illuminate a first portion of the vehicular exterior part and the second lighting source is adapted to illuminate a second portion of the part.

In one embodiment, the lighting assembly 208 is low voltage, such as 12 volts or less. In another embodiment, the lighting assembly 208 operates on DC current.

The vehicle graphic system 200 further includes a power source (not shown) operably connected to the lighting assembly 208 and a support bracket adapted for supporting the lighting assembly 208 on the interior side 206 of the vehicular exterior part 202. The power source includes a battery, a generator or combinations thereof.

In one embodiment, the vehicular exterior part 202 is adapted to illuminate independently of the vehicle. In another embodiment, the vehicular exterior part 202 adapted to illuminate upon ignition of the vehicle.

The vehicle graphic system 200 can further include a cover 212 connected to the vehicular exterior part and adapted to enclose the lighting system 208 within the vehicular exterior part 202. The cover 212 is adapted to protect the vehicle graphic system 200 from damage due to backfire.

1. A vehicle graphic system comprising:
a. a replaceable, removable vehicular exterior part, wherein the vehicular exterior part comprises an interior side and an exterior side;
b. a graphic cutout formed in the exterior part and extending through the interior side and the exterior side;
c. a lighting assembly disposed proximate the interior side of the vehicular exterior part, wherein the lighting assembly is adapted to illuminate the graphic cutout;
d. a power source operably connected to the lighting assembly; and
e. a support bracket adapted for supporting the lighting assembly on the interior side of the part.

2. The vehicle graphic system of claim 1, wherein a message is formed in the graphic cutout.

3. The vehicle graphic system of claim 1, wherein the graphic cutout is formed by cutting, stamping or combinations thereof.

4. The vehicle graphic system of claim 3, wherein the cutting comprises laser jet cutting or water cutting.

5. The vehicle graphic system of claim 1, wherein the graphic cut out is a symbol.

6. The vehicle graphic system of claim 1, wherein the graphic cut is lined with a transparent material.

7. The vehicle graphic system of claim 6, wherein the transparent material is tinted.

8. The vehicle graphic system of claim 6, wherein the transparent material is polarized.

9. The vehicle graphic system of claim 1, wherein the interior side of the graphic cut out is lined with a transparent material.

10. The vehicle graphic system of claim 6, wherein the transparent material is tinted

11. The vehicle graphic system of claim 6, wherein the transparent material is polarized.

12. The vehicle graphic system of claim 1, wherein the lighting assembly comprises a plurality of lighting sources.

13. The vehicle graphic system of claim 12, wherein the lighting source is selected from the group consisting of fiber optic filaments, neon optic source, an incandescent light, an LED and combinations thereof.

14. The vehicle graphic system of claim 12, wherein the plurality of lighting sources includes at least a first lighting source and at least a second lighting source, the first lighting source adapted to illuminate a first portion of the vehicular exterior part and the second lighting source is adapted to illuminate a second portion of the part.

15. The vehicle graphic system of claim 1, wherein the vehicular exterior part is an air filter cover

16. The vehicle graphic system of claim 1, wherein the vehicular exterior part is selected from the group consisting of a battery cover, a horn cover, a valve cover, a gas tank attachment, a front fender attachment, a front fender, a rear fender, a rear fender attachment, a carburetor cover, an engine cover and combinations thereof.

17. The vehicle graphic system of claim 1, wherein the vehicular exterior part is a motorcycle part.

18. The vehicle graphic system of claim 17, wherein the vehicular exterior part is bolted onto the motorcycle.

19. The vehicle graphic system of claim 1, wherein the vehicular exterior part is mounted on an automobile.

20. The vehicle graphic system of claim 1, wherein the vehicular exterior part is mounted on a boat.

21. The vehicle graphic system of claim 1, wherein the power source comprises a battery, a generator or combinations thereof.

22. The vehicle graphic system of claim 1, wherein the vehicular exterior part is adapted to illuminate independently of the vehicle.

23. The vehicle graphic system of claim 1, wherein the vehicular exterior part is adapted to illuminate upon ignition of the vehicle.

24. The vehicle graphic system of claim 1 further comprising a cover connected to the vehicular exterior part and adapted to enclose the lighting system within the vehicular exterior part.

25. The vehicle graphic system of claim 1, wherein the lighting system is 12 volts or less.

26. The vehicle graphic system of claim 25, wherein the power source is a DC current.

27. A motorcycle graphic system comprising:
a. a replaceable, removable motorcycle exterior part, wherein the motorcycle exterior part comprises an interior side and an exterior side;
